(19) United States
(12) Patent Application Publication
(10) Pub. No.: US 2026/0102841 A1
(43) Pub. Date: Apr. 16, 2026

(54) Fixture and Method for Improving the Performance of Electromagnetic Pulse Welding Joints

(71) Applicant: Nanchang Hangkong University, Nanchang City (CN)

(72) Inventors: Jilin XIE, Nanchang City (CN); Hangyu LI, Nanchang City (CN); Yuhua CHEN, Nanchang City (CN); Minjuan WANG, Nanchang City (CN); Shanlin WANG, Nanchang City (CN); Shimeng LI, Nanchang City (CN); Jishuai LI, Nanchang City (CN); Timing ZHANG, Nanchang City (CN); Min ZHENG, Nanchang City (CN)

(73) Assignee: Nanchang Hangkong University, Nanchang City, JX (CN)

(21) Appl. No.: 19/418,979

(22) Filed: Dec. 13, 2025

(30) Foreign Application Priority Data
May 8, 2025 (CN) 202510589274.7

(51) Int. Cl. B23K 20/06; B23K 13/01; H05B 6/36

(52) U.S. Cl. CPC B23K 20/06; B23K 13/01; H05B 6/36

(57) ABSTRACT

The present invention provides a fixture and method for improving the performance of electromagnetic pulse welding joints. The fixture comprises a base and a pressing block. In the present invention, the pressing block and the base are closely attached to each other through the cooperation of a semi-through groove and a protrusion, and the pressing block is compacted by a pressing plate, so that the semi-through groove is sealed. The semi-through groove may be filled with a specific atmosphere through a suction hole and a gas conveying hole, so that welding may be completed under different atmospheres. By selecting the type of atmosphere, the resistance of a flyer plate and the associated energy loss caused by high-speed movement of the workpieces to be welded can be effectively reduced, so that the welding quality is ensured.

### TECHNICAL FIELD

The present invention relates to the technical field of electromagnetic pulse welding joint fixtures, and in particular, to a fixture and method for improving the performance of electromagnetic pulse welding joints.

### BACKGROUND

Electromagnetic pulse welding (MPW) is a cold welding process that relies on high-speed impact generated by electromagnetic induction to join two metal workpieces. Electromagnetic force accelerates one specimen (flyer plate) to impact another welding specimen (base plate), thereby generating the necessary impact and subsequent metal bonding between them.

During electromagnetic pulse welding (MPW), the welded joint is generally clamped with a fixture. The existing fixture is an open-type fit. During welding, the specimen is exposed to the air and can only be welded in an air environment. During the welding process, since the flyer plate has a large surface area, the air will be rapidly compressed in the welding area at a very high speed, causing a large resistance to the flyer plate, which will consume more energy.

In view of this, the inventors have specifically designed a fixture and method for improving the performance of electromagnetic pulse welding joints, and the present case arises therefrom.

### SUMMARY OF THE INVENTION

In order to solve the above problems, the technical solution of the present invention is as follows:

A fixture for improving the performance of electromagnetic pulse welding joints, which is arranged on a welding workbench and used for clamping workpieces to be welded, wherein the welding workbench is provided with an electromagnetic pulse assembly, the fixture includes a base and a pressure block, the base is sealingly embedded on the electromagnetic pulse assembly, a semi-through groove is opened on the top of the base, a support plate and a through opening are provided at the bottom of the semi-through groove, a protrusion matching the semi-through groove is provided at the bottom of the pressure block, an air extraction hole and an air supply hole are opened on the side of the pressure block, the air extraction hole and the air supply hole are both in communication with the semi-through groove, the welding workbench is also provided with a pressure plate that can move linearly up and down, the pressure block is fixedly connected to the pressure plate, and the pressure block is pressed against the base through the pressure plate.

Preferably, a ring of protrusions is arranged around the semi-through groove, a ring of sealing gaskets is placed outside the protrusions, and a ring of grooves is arranged at the bottom of the pressure block, and the grooves are sealingly engaged with the protrusions.

Preferably, an installation groove is arranged at the bottom of the base, and the installation groove is sealingly matched with the electromagnetic pulse assembly.

Preferably, the plane where the pressure block is located is parallel to the plane where the workpiece to be welded is located.

Preferably, the air extraction hole and the air supply hole each include a horizontal section and a vertical section that are connected to each other, the horizontal section of the air extraction hole is connected to an external air extraction device, the vertical section of the air extraction hole is connected to the semi-through groove, the horizontal section of the air supply hole is connected to an external air supply device, the vertical section of the air supply hole is connected to the semi-through groove, and the vertical section of the air extraction hole and the vertical section of the air supply hole are both arranged above the through opening.

Preferably, two first threaded holes are arranged on the base, the base is threadedly connected to the electromagnetic pulse assembly, and second threaded holes are respectively arranged at four corners of the pressure block, and the pressure block is threadedly connected to the pressure plate.

Preferably, the through opening is a rectangle of 50 mm×90 mm.

The present invention also discloses a method for using a fixture for improving the performance of electromagnetic pulse welding joints, the method steps include:
S1. Placing the workpiece to be welded: sealingly fitting the base of the fixture with the electromagnetic pulse assembly, the workpiece to be welded includes a flyer plate and a base plate, the flyer plate is located in the through opening and is connected to the electromagnetic pulse assembly, gaskets are arranged on both sides of the upper end surface of the flyer plate, the base plate is arranged on the top of the flyer plate, and the lower end surface of the base plate is in contact with the two gaskets.
S2. Performing sealing: moving the pressure plate downward to press the pressure block against the base, completing the sealing;
S3. Extracting air through the air extraction hole and inputting specific gas through the air supply hole;
S4. Energizing the electromagnetic pulse assembly, the flyer plate is subjected to electromagnetic force, and the welding between the flyer plate and the base plate is completed.

Preferably, the specific gas is 0.1 MPa atmosphere or 0.04 MPa atmosphere or Ar.

The technical solution provided by the present invention has the following beneficial effects:
1. The present invention realizes the close contact between the pressure block and the base through the cooperation of the semi-through groove and the protrusion, and then compacts the pressure block through the pressure plate moving up and down, so that the semi-through groove is sealed, and then the semi-through groove is kept in vacuum through the air extraction hole and the air supply hole, and then filled with a specific atmosphere, so that the workpiece to be welded is welded in different atmospheres. By selecting the type of atmosphere, the resistance of the flyer plate and the energy loss caused by the high-speed movement of the workpiece to be welded can be effectively reduced, and the welding quality can be ensured.
2. The present invention can effectively prevent gas leakage and ensure the airtightness of the inside of the fixture by arranging protrusions around the semi-through groove and placing a sealing ring outside the protrusions, which can better control the welding environment and reduce the interference of external air or impurities, thereby improving the welding quality.

### BRIEF DESCRIPTION OF THE DRAWINGS

The drawings described herein are used to provide a further understanding of the present invention and constitute a part of the present invention. The schematic embodiments of the present invention and their descriptions are used to explain the present invention and do not constitute an improper limitation of the present invention.

FIG. 1 is a schematic diagram of the overall structure of the present invention;

FIG. 2 is a schematic structural diagram of the base in the present invention;

FIG. 3 is a schematic structural diagram of the pressure block in the present invention;

FIG. 4 is a schematic cross-sectional structural diagram of the present invention;

FIG. 5 is a partially enlarged structural diagram of the location A in FIG. 4;

FIG. 6 is a cross-sectional characteristic diagram of the electromagnetic pulse welding joint of this embodiment;

FIG. 7 is a tensile curve diagram of the welding experimental effect of this embodiment and the specimen in an atmospheric environment;

FIG. 8 is a bar graph of the cross-sectional characteristic data of the welding experimental effect of this embodiment and the specimen in an atmospheric environment.

### DESCRIPTION OF REFERENCE NUMERALS

1. Welding workbench; 11. Pressure plate; 12. Electromagnetic pulse assembly; 2. Workpiece to be welded; 21. Flyer plate; 22. Base plate; 23. Gasket; 3. Base; 31. Semi-through groove; 32. Support plate; 33. Through opening; 34. Protrusion; 35. Sealing ring; 36. Installation groove; 37. First threaded hole; 4. Pressure block; 41. Protrusion; 42. Air extraction hole; 43. Air supply hole; 44. Second threaded hole; 5. Air extraction device; 6. Air supply device; 7. Annular welding area; 8. Central unwelded area.

### DETAILED DESCRIPTION OF THE INVENTION

In order to make the technical problems to be solved, the technical solutions and the beneficial effects of the present invention clearer and more comprehensible, the present invention will be further described in detail below with reference to the accompanying drawings and embodiments. It should be understood that the specific embodiments described herein are only used to explain the present invention and are not used to limit the present invention.

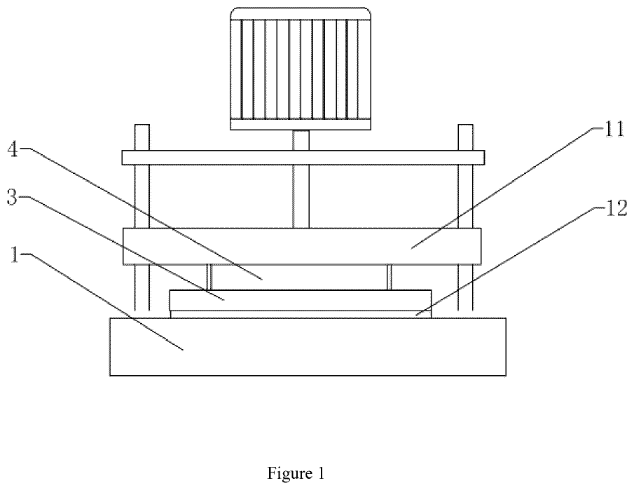

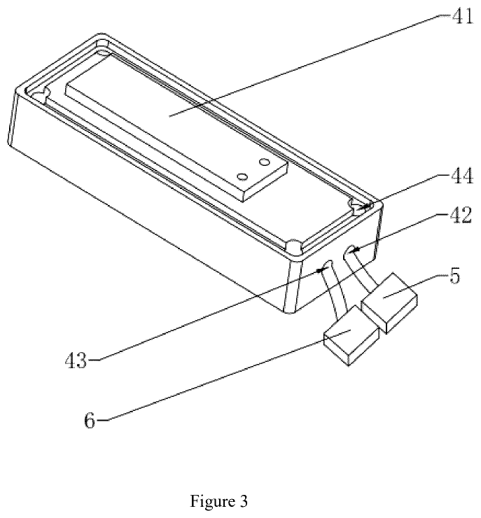

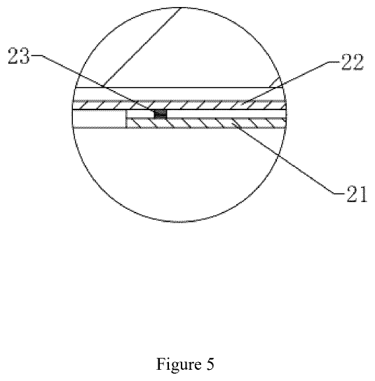

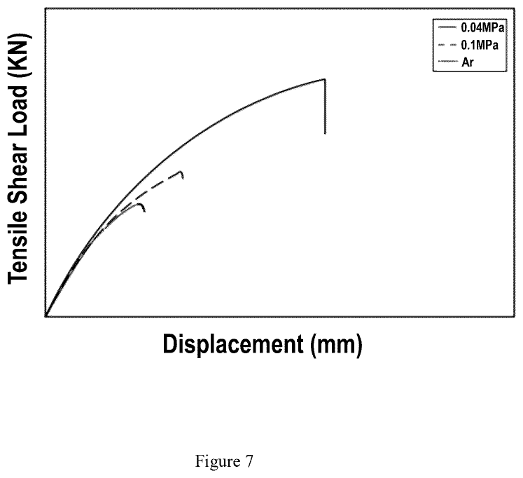

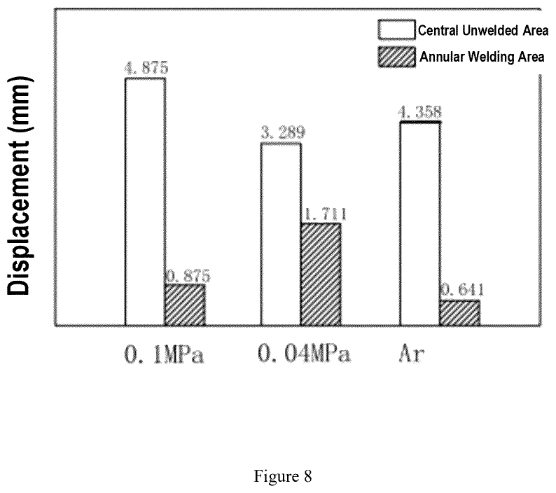

Please refer to FIGS. 1 to 8, which is a fixture for improving the performance of electromagnetic pulse welding joints as the best embodiment of the present invention, which is arranged on a welding workbench 1 and used for clamping workpieces 2 to be welded. The welding workbench 1 is provided with an electromagnetic pulse assembly 12. The electromagnetic pulse assembly 12 is provided with a boss, the boss is wrapped with insulating tape, and a built-in working coil, the fixture includes a base 3 and a pressure block 4, the base 3 is sealingly embedded on the electromagnetic pulse assembly 12, a semi-through groove 31 is opened on the top of the base 3, a support plate 32 and a through opening 33 are provided at the bottom of the semi-through groove 31, a protrusion 41 matching the semi-through groove 31 is provided at the bottom of the pressure block 4, an air extraction hole 42 and an air supply hole 43 are opened on the side of the pressure block 4, the air extraction hole 42 and the air supply hole 43 are both in communication with the semi-through groove 31, the welding workbench 1 is also provided with a pressure plate 11 that can move linearly up and down, the pressure block 4 is fixedly connected to the pressure plate 11, and the pressure block 4 is pressed against the base 3 through the pressure plate 11, the pressure plate 11 is driven by a cylinder, the electromagnetic pulse assembly 12 has a built-in working coil, the working coil is in contact with the through opening 33, the air extraction hole 42 and the air supply hole 43 are respectively connected to external air extraction equipment and air supply equipment, the air extraction device 5 is a vacuum pump, and the air supply device 6 is a gas cylinder. Before introducing gas, the air in the fixture is first extracted, and then the gas supply is adjusted to maintain the air pressure in the fixture, and the air extraction and gas supply are continued for a period of time to ensure the purity of the atmosphere during welding; through the design of the air extraction hole 42 and the air supply hole 43, the internal atmosphere environment of the fixture can be quickly switched (such as vacuum, inert gas, reducing gas, etc.) to adapt to the welding needs of different materials; the present invention realizes the close contact between the pressure block 4 and the base 3 through the cooperation of the semi-through groove 31 and the protrusion 41. At the same time, when the pressure block 4 and the base 3 are pressed together, there is a large gap between the semi-through groove 31 and the protrusion 41, which prevents the welding fixture from being repeatedly pulled and pressed and damaged during the welding process, further protecting the fixture, and then compacting the pressure block 4 through the pressure plate 11 moving up and down, so that the semi-through groove 31 is sealed, and then the semi-through groove 31 is filled with a specific atmosphere through the air extraction hole 42 and the air supply hole 43, so that the workpiece 2 to be welded is welded in different atmospheres. By selecting the type of atmosphere, the resistance of the flyer plate 21 and the energy loss caused by the high-speed movement of the workpiece 2 to be welded can be effectively reduced, and the welding quality can be ensured.

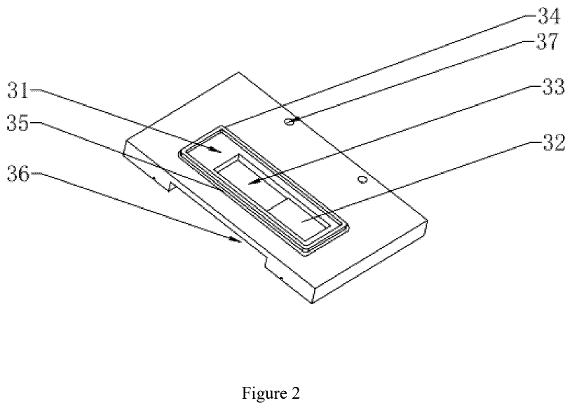

Specifically, please refer to FIGS. 2 to 5, a ring of protrusions 34 is arranged around the semi-through groove 31, a ring of sealing gaskets 23 is placed outside the protrusions 34, a ring of grooves is arranged at the bottom of the pressure block 4, and the grooves are sealingly engaged with the protrusions 34. The engaging structure of the protrusions 34 and the grooves combined with the sealing ring 35 can form multiple sealing barriers and effectively prevent gas leakage. During the welding process, the internal atmosphere environment of the fixture can be kept stable, avoiding the entry of external air and ensuring the welding quality; the engaging design of the protrusions 34 and the grooves increases the contact area between the base 3 and the pressure block 4, and the uniform pressure applied by the cylinder makes the connection between the pressure block 4 and the base 3 more stable, which can effectively prevent the fixture from loosening due to vibration or impact during the welding process and ensure the stability of the welding process.

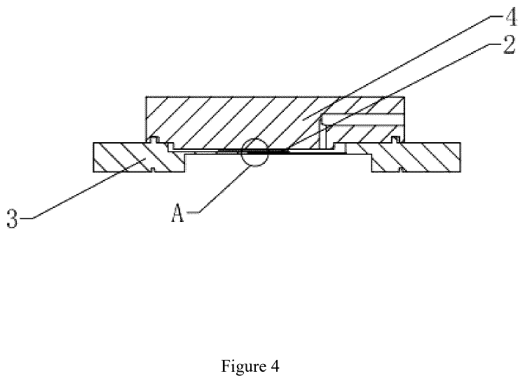

Specifically, please refer to FIGS. 2 and 4, an installation groove 36 is arranged at the bottom of the base 3, and the installation groove 36 is sealingly matched with the electromagnetic pulse assembly 12. The electromagnetic pulse assembly 12 is wrapped with insulating glue and has a built-in working coil. The base 3 is stuck with it through the installation groove 36. The upper surface of the electromagnetic coil is connected to the bottom surface of the installation groove 36. The flyer plate 21 is subjected to a vertically upward electromagnetic force, and an upward deformation will occur in the flyer plate 21 area at the pre-welding position, which will impact the base plate 22 at high speed. Under the combined action of mechanics and metallurgy, the welding effect is achieved. In a specific atmosphere environment, the welding between the flyer plate 21 and the base plate 22 is completed, which can avoid a large loss of energy of the flyer plate 21 and improve the welding quality of the weld. At the same time, the cooperation between the installation groove 36 and the electromagnetic pulse assembly 12 can ensure the accurate alignment between the base 3 and the electromagnetic pulse assembly 12 during installation, reduce installation errors, and can effectively improve the overall installation accuracy of the fixture and ensure the stable position of the workpiece during the welding process, reducing welding deviation.

Specifically, please refer to FIG. 4, the plane where the pressure block 4 is located is parallel to the plane where the workpiece 2 to be welded is located, ensuring that the pressure applied by the cylinder is evenly distributed on the entire contact surface of the workpiece 2 to be welded (flyer plate 21 and base plate 22), which can avoid excessive or insufficient local pressure, ensure that the collision energy between the flyer plate 21 and the base plate 22 is more concentrated during the welding process, and reduce welding deformation and defects. At the same time, the parallel arrangement makes the contact surface more uniform during the process of the flyer plate 21 impacting the base plate 22, reducing energy loss and improving welding quality.

Specifically, please refer to FIG. 4, the air extraction hole 42 and the air supply hole 43 each include a horizontal section and a vertical section that are connected to each other, the horizontal section of the air extraction hole 42 is connected to an external air extraction device 5, the vertical section of the air extraction hole 42 is connected to the semi-through groove 31, the horizontal section of the air supply hole 43 is connected to an external air supply device 6, the vertical section of the air supply hole 43 is connected to the semi-through groove 31, and the vertical section of the air extraction hole 42 and the vertical section of the air supply hole 43 are both arranged above the through opening 33. During the gas supply and air extraction process, the vertical section is located above the through opening 33, which facilitates the external air extraction device 5 and the external air supply device 6 to extract and transport gas, reducing the gas transportation time.

Specifically, please refer to FIG. 2, two first threaded holes 37 are arranged on the base 3, the base 3 is threadedly connected to the electromagnetic pulse assembly 12, and second threaded holes 44 are respectively arranged at four corners of the pressure block 4. Through the threaded connection, the connection between the base 3 and the electromagnetic pulse assembly 12 is more firm, which can effectively prevent the fixture from loosening due to vibration or impact during the welding process, ensuring the stability of the fixture during the welding process and reducing the welding quality degradation caused by the fixture loosening; at the same time, the threaded connection is simple and convenient during installation and disassembly, improving work efficiency.

Please refer to FIG. 1, the through opening 33 is a rectangle of 50 mm×90 mm. The size design of the rectangular through opening 33 can adapt to flyer plates 21 and base plates 22 of various sizes, providing greater flexibility; at the same time, the size of the rectangular through opening 33 matches the working area of the electromagnetic coil, which can ensure that the electromagnetic force is evenly applied to the flyer plate 21, reduce energy loss, and ensure that the high-speed collision energy between the flyer plate 21 and the base plate 22 is more concentrated, thereby improving the welding strength and quality. The size of the through opening 33 also has a certain impact on the sealing performance. The through opening 33 of this size reduces the extraction time when extracting the air inside the fixture.

Referring to FIGS. 1 to 5, the second aspect of the embodiment of the present application also provides a method for using a fixture for improving the performance of electromagnetic pulse welding joints, using the fixture of any of the above embodiments, specifically, including the following steps:
S1. Placing the workpiece 2 to be welded: sealingly fitting the base 3 of the fixture with the electromagnetic pulse component 12, the workpiece 2 to be welded including a flyer plate 21 and a substrate 22, the flyer plate 21 being located within the through-opening 33 and connected to the electromagnetic pulse component 12, shims 23 being provided on both sides of the upper end surface of the flyer plate 21, the substrate 22 being provided on the top of the flyer plate 21, the substrate 22 being placed on the support plate 32, and the lower end surface of the substrate 22 being in contact with the two shims 23;
S2. Performing sealing: driving the cylinder to drive the pressure plate 11 to move downwards, so that the pressure block 4 is connected to the base 3, and the groove of the pressure block 4 is engaged with the protrusion 34, to complete the sealing;
S3. The air extraction hole 42 extracts air through the air extraction device 5, and the air supply hole 43 inputs a specific atmosphere through the ventilation device 6, and then the air supply amount is adjusted to maintain the air pressure in the fixture, and the air extraction and air supply are continued for a period of time to ensure the purity of the atmosphere during welding;
S4. Energizing the electromagnetic pulse component 12, the flyer plate 21 is subjected to a vertically upward electromagnetic force, and a partial area of the flyer plate 21 near the coil generates an upward deformation, and impacts the substrate 22 at high speed, and is subjected to the combined action of mechanics and metallurgy to achieve the welding effect.

In step S1, the effective action range of the electromagnetic coil is a rectangle with a length greater than the width of the flyer plate 21. The pre-welded position of the flyer plate 21 is placed above the action of the electromagnetic coil. The flyer plate 21 is subjected to a vertically upward electromagnetic force, and the flyer plate 21 area at the pre-welded position generates an upward deformation, and impacts the substrate 22 at high speed, and is subjected to the combined action of mechanics and metallurgy to achieve the welding effect; in a specific atmosphere environment, the welding between the flyer plate 21 and the substrate 22 is completed, which can avoid a large amount of energy loss of the flyer plate 21 and improve the welding quality of the weld. The shims 23 on both sides of the flyer plate 21 can ensure that the contact pressure between the substrate 22 and the flyer plate 21 is evenly distributed, avoiding excessive or insufficient local pressure. The uniform pressure distribution can ensure that the collision energy between the flyer plate 21 and the substrate 22 is more concentrated during the welding process, reducing welding deformation and defects. At the same time, the shims 23 between the flyer plate 21 and the substrate 22 can provide space for the acceleration of the flyer plate 21, thereby affecting the flight and collision behavior of the flyer plate 21, and can also effectively absorb the impact force during the welding process, reduce the stress concentration of the welded joint, and help obtain a high-quality welded joint and reduce welding defects.

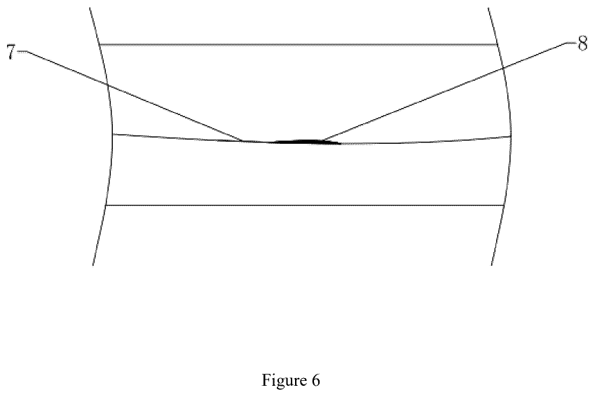

Specifically, please refer to FIGS. 6 to 8. The specific gas is 0.1 MPa atmosphere or 0.04 MPa atmosphere or Ar. In this embodiment, the fixture is evacuated and then these three gases are delivered to detect the performance of the workpiece after welding. In the existing electromagnetic pulse welding, when the flyer plate 21 moves in the air, the air resistance causes its kinetic energy to decay radially, and the speed in the central area is insufficient, making it difficult to reach the critical welding speed, and the impact wave energy distribution is uneven: the flyer plate 21 deforms under the action of electromagnetic force, and the edge area contacts the substrate 22 first, while the central area fails to effectively combine due to inertial lag, which will lead to the generation of an annular welding zone 7 and a central unwelded zone 8 that fails to be welded after the welding is completed. The existing fixture makes the welding process in an air environment, and the welding quality is poor and the central unwelded zone 8 is large. This solution can flexibly adjust the welding atmosphere to reduce the central unwelded zone 8 and improve the welding quality. In the embodiment provided by the present invention, the atmospheric pressure of the specific atmosphere is 0.04 MPa. Compared with the samples obtained by electromagnetic pulse welding under 0.1 MPa atmospheric pressure and Ar, the range of the central unwelded zone 8 is reduced, the annular welding zone 7 is increased, and the tensile shear load is large, and the welding quality is good.

In summary, the present invention cooperates the semi-through groove 31 with the protrusion 41 to make the pressure block 4 and the base 3 fit together, and then compacts the pressure block 4 through the pressure plate 11 moving up and down, so that the semi-through groove 31 is sealed, and then the semi-through groove 31 is filled with a specific atmosphere through the air extraction hole 42 and the air supply hole 43, so that the workpiece 2 to be welded can be welded in different atmospheres. By selecting the type of atmosphere, the resistance of the flyer plate 21 and the energy loss caused by the high-speed movement of the workpiece 2 to be welded can be effectively reduced, and the welding quality can be guaranteed.

The present invention has been exemplarily described above in conjunction with the accompanying drawings. Obviously, the specific implementation of the present invention is not limited by the above-mentioned manner. As long as various non-substantial improvements are made by adopting the inventive concept and technical solution of the present invention, or the inventive concept and technical solution of the present invention are directly applied to other occasions without improvement, they all fall within the protection scope of the present invention.

1. A fixture for improving the performance of electromagnetic pulse welding joints, comprising a welding workbench (1) for clamping a workpiece (2) to be welded, wherein the workbench is provided with an electromagnetic pulse assembly (12), a base (3) and a pressure block (4), wherein the base (3) is sealed and embedded in the electromagnetic pulse assembly (12);
wherein the top of the base (3) comprises a semi-through groove (31), and wherein a support plate (32) and a through hole (33) are provided at the bottom of the semi-through groove (31); wherein the bottom of the pressure block (4) is provided with a protrusion (41) that mates with the semi-through groove (31); and a side of the pressure block (4) is provided with an air extraction hole (42) and an air delivery hole (43), both of which communicate with the semi-through groove (31); wherein the welding workbench (1) is also provided with a pressure plate (11) that can move linearly up and down; wherein the pressure block (4) is fixedly connected to the pressure plate (11), and the pressure block (4) is pressed against the base (3) through the pressure plate (11).

2. The fixture for improving the performance of an electromagnetic pulse welding joint according to claim 1, characterized in that a ring of protrusions (34) is provided around the semi-through groove (31), a ring of sealing gaskets (23) is placed outside the protrusions (34); and a ring of grooves is provided at the bottom of the pressure block (4), with the grooves sealingly engaging with the protrusions (34).

3. The fixture for improving the performance of an electromagnetic pulse welding joint according to claim 1, characterized in that the bottom of the base (3) is provided with a mounting groove (36), and the mounting groove (36) is in a sealed fit with the electromagnetic pulse assembly (12).

4. The fixture for improving the performance of an electromagnetic pulse welding joint according to claim 1, characterized in that the plane of the pressure block (4) is parallel to the plane of the workpiece (2) to be welded.

5. The fixture for improving the performance of an electromagnetic pulse welding joint according to claim 1, characterized in that both the extraction hole (42) and the air supply hole (43) include interconnected horizontal and vertical sections; wherein the horizontal section of the extraction hole (42) is connected to an external extraction device (5), and the vertical section of the extraction hole (42) is connected to a semi-through groove (31); wherein the horizontal section of the air supply hole (43) is connected to an external ventilation device (6), and the vertical section of the air supply hole (43) is connected to the semi-through groove (31); and wherein both the vertical sections of the extraction hole (42) and the air supply hole (43) are located above the through-hole (33).

6. The fixture for improving the performance of an electromagnetic pulse welding joint according to claim 1, characterized in that the base (3) is provided with two first threaded holes (37), the base (3) is threadedly connected to the electromagnetic pulse assembly (12), and the pressure block (4) is provided with second threaded holes (44) at its four corners, and the pressure block (4) is threadedly connected to the pressure plate (11).

7. The fixture for improving the performance of an electromagnetic pulse welding joint according to claim 1, characterized in that the through-hole (33) is a rectangle of 50 mm×90 mm.

8. A clamping method for a fixture for improving the performance of an electromagnetic pulse welding joint as described in claim 1, characterized in that it includes the following steps:
S1, placing the workpiece to be welded (2), comprising sealing and fitting the base (3) of the fixture with the electromagnetic pulse assembly (12), wherein the workpiece to be welded (2) includes a fly plate (21) and a base plate (22), wherein the fly plate (21) is located in the opening (33) and connected to the electromagnetic pulse assembly (12), and gaskets (23) are provided on both sides of the upper end face of the fly plate (21); wherein a base plate (22) is provided on the top of the device, and the base plate (22) is placed on the support plate (32); wherein the lower end face of the base plate (22) is in contact with two gaskets (23);
S2, sealing, wherein the pressure plate (11) moves downward, so that the pressure block (4) presses against the base (3) to complete the seal;
S3, introducing a specific gas through the air supply hole (43), wherein air is drawn out through the air extraction hole (42);
S4, energizing the electromagnetic pulse assembly (12), wherein the fly plate (21) is subjected to electromagnetic force to complete the welding with the base plate (22).

9. The clamping method of the fixture for improving the performance of electromagnetic pulse welding joints according to claim 8, wherein the specific gas is 0.1 MPa atmospheric pressure or 0.04 MPa atmospheric pressure or Ar.
